(19) United States
(12) Patent Application Publication
(10) Pub. No.: US 2026/0158659 A1
(43) Pub. Date: Jun. 11, 2026

(54) CONTACT CONTROL-BASED ROBOT CALIBRATION

(71) Applicant: Intrinsic Innovation LLC, Mountain View, CA (US)

(72) Inventors: Filippos Edward Sotiropoulos, Munich (DE); Andre Gaschler, Munich (DE)

(21) Appl. No.: 18/972,257

(22) Filed: Dec. 6, 2024

(51) Int. Cl. B25J 9/16; B25J 13/08

(52) U.S. Cl. CPC B25J 9/1692; B25J 9/1653; B25J 9/1664; B25J 13/085

(57) ABSTRACT

Methods, systems, and apparatus, including computer programs encoded on computer storage media, for calibrating a robot in a workcell. One of the methods includes causing the robot to move an end effector to make contact with multiple points on a calibration object within the workcell; for each of the multiple points at which the end effector made contact with the calibration object: reading joint configurations of the robot when the robot is holding the end effector in contact with the point; and determining a target location of the point in the end effector coordinate frame based on a known geometry of the calibration object; and determining, based on (i) the read joint configurations of the robot and (ii) the target locations of the points in the end effector coordinate frame, a robot flange-to-end effector transformation between the robot flange coordinate frame and the end effector coordinate frame.

### BACKGROUND

This specification relates to robotics, and more particularly to robot calibration in an operating environment.

In robotics, the physical movements of robots in order to perform tasks are often scheduled by manual pre-programming. For example, a warehouse robot that moves boxes can be programmed to pick up a box at the entrance of a warehouse, move it, and put it down in a target zone of the warehouse. For another example, a construction robot can be programmed to pick up a beam and put it down onto a bridge deck. As each of these actions can include many movements that require high precision, a slight error in measurement of a robot pose can result in failure of the task. Moreover, errors at an early stage in the process can result in accumulated errors in robot movements later in the task, further resulting in failed tasks using a pre-programmed schedule.

In an ideal operating scenario, the positions and orientations of each of a plurality of objects and robots in a workcell are always measured perfectly with respect to a reference coordinate frame, e.g., the coordinate frame of a world model. For example, an ideal scenario would have the plurality of objects and robots positioned exactly as expected in a CAD model for the workcell upon which a pre-programmed work flow is based.

However, in reality there is often some difference between the actual locations of robots and objects and the recorded initial positions, which can occur at installation or when the components are calibrated. This can result in errors of disagreement. In addition, real poses of robots and objects can be different from expected poses because robots and objects can be physically moved while performing task. Thus, one or more current poses of the robots and objects can deviate from respective expected poses. Calibration errors can also accumulate, particularly when a component, e.g., a tool on a robot, is moved far away from the robot base. Thus it is often challenging to guarantee successful workcell performance due to accumulated errors from miscalibrated components.

### SUMMARY

This specification describes techniques for calibrating a robot relative to an external reference frame. The robot has physical characteristics that can be defined by a calibration model of the robot, and the calibration of the robot involves the determination of the refined (i.e., calibrated) values of the parameters of the calibration model.

The external reference frame can be any reference frame. For example, the external reference frame can be an object coordinate frame defined by an object, e.g., a calibration object, or a workpiece. As another example, the external reference frame can be an end effector coordinate frame defined by an end effector of the robot.

Particular embodiments of the subject matter described in this specification can be implemented so as to realize one or more of the following advantages.

In the field of robotics, the knowledge of the physical characteristics of the robot is important to calculate the exact position of the robot. These physical characteristics may be defined by a calibration model of the robot, but will vary depending on the assembling process of the robots and the tolerance of its components. In order to refine the knowledge and thereby enhance robot accuracy, it is necessary to calibrate the robot to update the calibration model. Although there exists many ways of calibrating a robot, all of them require some kind of additional active measurement equipment, e.g., a camera, a laser scanner, or another sensor, and specialized knowledge of how to use the measurement equipment, and furthermore rely on the accuracy by which the physical characteristics of the equipment is known.

The calibration techniques described in this specification do not depend on the precision of external active measurement equipment—only a passive, contact sensor is used. To calibrate the robot, the described calibration techniques manipulate the robot to make contact with a calibration object placed in a workcell that includes the robot, and obtain information including the joint configurations of the robot and the locations of the contact points, which is then used to update the calibration model of the robot, i.e., to determine refined values of the parameters of the calibration model. The calibration object need not be custom manufactured for a particular robot or a particular workcell. Instead, it can be any three-dimensional object (an object that has a 3-D shape) the geometry of which is known. Using the described calibration techniques to calibrate the robot can achieve or even exceed the calibration accuracy of an existing calibration technique method that requires the additional active measurement equipment, despite a calibration process that is easy to setup, fast, and cost effective.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system that can calibrate a robot having an end effector in an operating environment.

FIG. 2 illustrates an example of coordinate frames included in a calibration model.

FIG. 3 illustrates examples of a calibration object that can be used in a contact control-based robot calibration process.

FIG. 4 is a flow diagram of an example process of contact control-based robot calibration.

FIG. 5 is a flow diagram of sub-steps of one of the steps of the process of FIG. 4.

Like reference numbers and designations in the various drawings indicate like elements.

### DETAILED DESCRIPTION

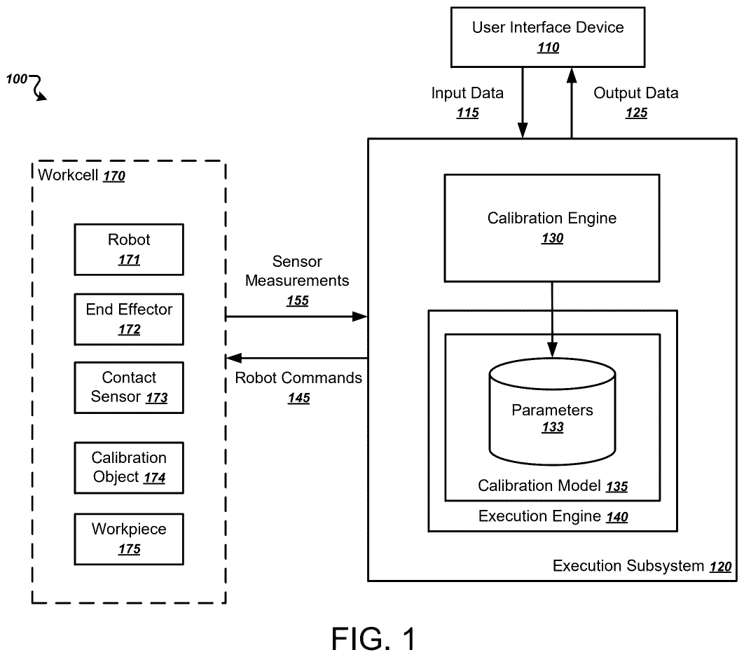

FIG. 1 is a block diagram of an example system 100 that can calibrate a robot 171 having an end effector 172 in an operating environment. After the robot 171 is calibrated, the system 100 can control the robot 171 to perform one or more tasks. The operating environment defines a work area for the robot 171. In this example, a robot workcell 170 is used as an example operating environment. The techniques described in this specification can also be used to calibration robots for other operating environments that are not workcells.

The functional components of the system 100 include a user interface device 110 and an execution subsystem 120. The execution subsystem 120 includes a calibration engine 130 and an execution engine 140. The functional components of the system 100 can be implemented as computer programs installed on one or more computers in one or more locations that are coupled to each other through any appropriate communications network, e.g., an intranet or the Internet, or a combination of networks.

Users of the system 100 may provide input data 115 to the system 100 using the user interface device 110. The user interface device 110 of the system can be any appropriate stationary or mobile computing device, for example, a desktop computer, a workstation in a robot factory, a tablet, a smartphone, or a smartwatch, to name just a few examples.

The user interface device 110 provides input data 115 to the execution subsystem 120, and the execution subsystem 120, in turn, generates robot commands 145 to drive the execution of the robot 171 in the workcell 170 to perform one or more tasks according to the input data 115.

In this specification, a task is an operation to be performed by an end effector. For brevity, when a robot has only one end effector, a task can be described as an operation to be performed by the robot as a whole. Example tasks include grasping, welding, glue dispensing, part positioning, and surfacing sanding, to name just a few examples.

The input data 115 can include data that defines a robot trajectory, e.g., a joint trajectory or an end effector trajectory, for the robot 171 in the workcell 170 to follow. In this specification, a “joint trajectory” refers to a sequence of joint configurations (e.g., joint angles) in a joint coordinate frame that are implemented, one after another, while robot 171 performs one or more actions. An “end effector trajectory,” by contrast, refers to a trajectory of the end effector 172 in a Cartesian coordinate frame.

For example, the robot trajectory can be a trajectory along an edge of a workpiece 175 along which the robot 171 will apply a deburring tool. In another example, the robot trajectory can be a trajectory on a workpiece 175 along which the robot 171 will apply glue. In some cases, the robot trajectory is an offline robot trajectory that is calculated during downtimes of robot 171, i.e., while robot 171 is “offline.”

To control the robot 171 to follow the robot trajectory, the execution engine 140 includes a calibration model 135, and is configured to generate the robot commands 145 that control the joints or other movable components of the robot 171 based on the calibration model 135. The calibration model 135 includes information that defines a spatial relationship between the robot 171 and another object in the workcell 170. For example, the other object can be the end effector 172, the calibration object 174, or the workpiece 175.

More specifically, the calibration model 135 can include several coordinate frames, and a set of parameters 133 that define transformations for transforming positions and/or orientations from one of the coordinate frames to another of the coordinate frames. For example, the set of parameters 133 can include rotational and translational parameters that define the spatial relationship between the robot 171 and the other objects in the workcell 170.

The calibration model 135 makes it possible for the execution engine 140 to generate the robot commands 145 based on computing the forward and/or inverse transformation of positions and/or orientations in one of the coordinate frames to positions and/or orientations in any other of the coordinate frames. As an example, the execution engine 140 can do this based on screw theory as described in “A mathematical introduction to robotic manipulation” by Murray et al., published in 1994.

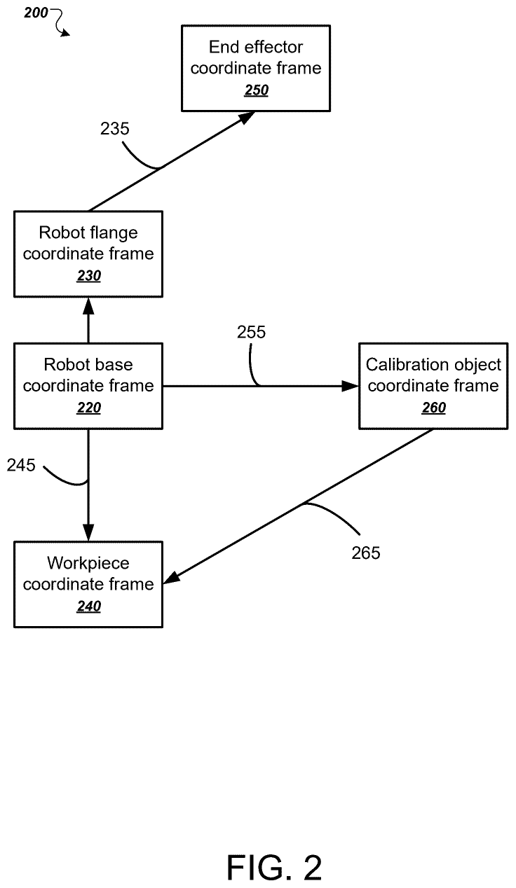

FIG. 2 illustrates an example of coordinate frames included in a calibration model 200. As illustrated, the calibration model 200 includes a robot base coordinate frame 220 that can be used to model a position and/or orientation of a robot, e.g., the robot 171 of FIG. 1. In some cases, the robot base coordinate frame 220 is centered about a rotational center or isocenter of the base of the robot, although it alternatively can be placed at any other appropriate location of the robot. In some cases, the z-axis of the robot base coordinate frame 220 is oriented vertically with respect to a floor or surface on which the robot is placed and/or orthogonal to the surface of the base of the robot.

The calibration model 200 also includes a robot flange coordinate frame 230 that can be used to model a position and/or orientation of a flange of the robot that interfaces an end effector. In some cases, the robot flange coordinate frame 230 is centered about a rotational center or isocenter of a surface of a distal end of the robot arm on which the end effector is attached, although it alternatively can be placed at any other appropriate location of the robot. In some cases, the z-axis of the robot flange coordinate frame 230 is oriented vertically with respect to the surface of a distal end of the robot arm.

The calibration model 200 also includes a workpiece coordinate frame 240 that is used to model a position and/or orientation of a workpiece, e.g., the workpiece 175 of FIG. 1. In some cases, the workpiece coordinate frame 240 is centered about a rotational center or a center of mass of the workpiece, although it alternatively can be placed at any other appropriate location of the workpiece, e.g., at one of the corners or vertices of the workpiece. In some cases, the z-axis of the workpiece coordinate frame 240 is oriented vertically with respect to a floor or surface on which the workpiece is placed and/or orthogonal to the surface of the workpiece.

The calibration model 200 also includes an end effector coordinate frame 250 that is used to model a position and/or orientation of an end effector, e.g., the end effector 172 of FIG. 1. In some cases, the end effector coordinate frame 250 is centered about a rotational center or a center of mass of the end effector, although it alternatively can be placed at any other appropriate location of the end effector. In some cases, the z-axis of the end effector coordinate frame 250 is oriented vertically with respect to a surface of a distal end of the robot arm on which the end effector is attached and/or orthogonal to the surface of the distal end of the robot arm.

The calibration model 200 also includes a calibration object coordinate frame 260 that is used to model a position and/or orientation of a calibration object, e.g., the calibration object 174 of FIG. 1. In some cases, the calibration object coordinate frame 260 is centered about a rotational center or a center of mass of the calibration object, although it alternatively can be placed at any other appropriate location of the workpiece, e.g., at one of the corners or vertices of the workpiece. In some cases, the z-axis of the calibration object coordinate frame 260 is oriented vertically with respect to a floor or surface on which the calibration object is placed and/or orthogonal to the surface of the calibration object.

In some cases, the calibration model 200 includes a world coordinate frame (that is different from any of the coordinate frames mentioned above) for the operation environment, e.g., the workcell 170 of FIG. 1. In other cases, one of the robot coordinate frame 230, the end effector coordinate frame 240, the workpiece coordinate frame 250, or the calibration object coordinate frame 260 is used by the calibration model 200 as the world coordinate frame for the operation environment.

The calibration model 200 further includes a set of parameters that define transformations between any two coordinate frames in the coordinate frames explained above. Such a transformation can be used for transforming positions and/or orientations from one of the coordinate frames to another of the coordinate frames.

In some implementations, the calibration model 200 includes a set of parameters that define a robot flange-to-end effector transformation 235 between the robot flange coordinate frame 230 and the end effector coordinate frame 250. In some cases, such a set of parameters include three rotational parameters: a yaw angle representing a rotation of the z-axis of the end effector coordinate frame 250 around the z-axis of the robot flange coordinate frame 230, a pitch angle representing a rotation around the y-axis of the end effector coordinate frame 250 around the y-axis of the robot flange coordinate frame 230, and a roll angle representing a rotation around the x-axis of the end effector coordinate frame 250 around the x-axis of the robot flange coordinate frame 230; and three translational parameters: distances x, y, and z of the center of the end effector coordinate frame 250 along the x, y, and z-axes, respectively, of the center of the robot flange coordinate frame 230.

In some implementations, the calibration model 200 includes a set of parameters that define a robot base-to-workpiece transformation 245 between the robot base coordinate frame 220 and the workpiece coordinate frame 240. In some cases, such a set of parameters include three rotational parameters: a yaw angle representing a rotation of the z-axis of the workpiece coordinate frame 240 around the z-axis of the robot base coordinate frame 220, a pitch angle representing a rotation around the y-axis of the workpiece coordinate frame 240 around the y-axis of the robot base coordinate frame 220, and a roll angle representing a rotation around the x-axis of the workpiece coordinate frame 240 around the x-axis of the robot base coordinate frame 220; and three translational parameters: distances x, y, and z of the center of the workpiece coordinate frame 250 along the x, y, and z-axes, respectively, of the center of the robot coordinate frame 230.

In some implementations, the calibration model 200 includes a set of parameters that define a robot base-to-calibration object transformation 255 between the robot base coordinate frame 220 and the calibration object coordinate frame 260. In some cases, such a set of parameters include three rotational parameters that define the rotations of the calibration object coordinate frame 260 around the x, y, and z-axes, respectively, of the robot base coordinate frame 220; and three translational parameters that define the distances x, y, and z of the center of the calibration object coordinate frame 260 along the x, y, and z-axes, respectively, of the center of the robot base coordinate frame 220.

In some implementations, the calibration model 200 includes a set of parameters that define a calibration object-to-workpiece transformation 265 between the calibration object coordinate frame 260 and the workpiece coordinate frame 240. In some cases, such a set of parameters include three rotational parameters that define the rotations of the workpiece coordinate frame 240 around the x, y, and z-axes, respectively, of the calibration object coordinate frame 260; and three translational parameters that define the distances x, y, and z of the center of the workpiece coordinate frame 240 along the x, y, and z-axes, respectively, of the center of the calibration object coordinate frame 260.

Turning back to FIG. 1, the execution engine 140 can use the calibration model 135 to map the desired positions and/or orientations along a robot trajectory in one coordinate frame, e.g., a joint coordinate frame or a Cartesian coordinate frame, that is defined in the input data 115 into robot commands 145 for physically moving the one or more movable components of the robot 171 to the desired positions or poses according to the input data 115.

For example, when the input data 115 includes data that defines an end effector trajectory, the execution engine 140 can use the calibration model 135 to compute a set of joint configurations based on the Cartesian coordinates, and then map the set of joint configurations into robot commands 145 for physically moving the one or more movable components of the robot 171 to the desired positions or poses along the end effector trajectory. In this example, the set of joint configurations can be computed by applying a set of inverse kinematics equations to the end effector trajectory in accordance with the set of parameters 133 included in the calibration model 135.

Whether the robot commands 145 generated by the execution engine 140 can result in successful completion of the tasks will depend on the calibration model 135 and, in particular, on the values of the set of parameters 133 include in the calibration model 135. In general, the more accurate the values of the set of parameters 133 are in terms of defining the spatial relationship between the robot 171 and other objects in the workcell 170, the greater the accuracy of the robot commands 145 that can be generated by using the calibration model 135 will achieve in terms of controlling the robot 171 to follow the desired positions and/or orientations along the robot trajectory.

Thus, FIG. 1 illustrates that the execution system 120 uses the calibration engine 130 to update the values of the set of parameters 113 included in calibration model 135, i.e., to generate refined (or optimized) values of the parameters 113 from their initial values. The refined (or optimized) values can more accurately define the spatial relationship between the robot 171 and the other objects in the workcell 170 than the initial values. For example, the initial values can be received from the user interface device 110. As another example, the initial values can be values that are determined by the execution system 120 based on an initial estimation of the physical characteristics of the robot 171 and the layout of the workcell 170.

In particular, the calibration engine 130 generates the refined (or optimized) values of the set of parameters 113 by performing a contact control-based robot calibration process that makes use of a contact sensor 173 and a calibration object 174 that are both included in the workcell 170. After the completion of the contact control-based robot calibration process, the calibration engine 130 can store the refined values of the set of parameters 133 in a storage device for later use, e.g., in a storage device accessible by the execution engine 140 for its use in generating robot commands 145 for physically moving the one or more movable components of the robot 171. Alternatively or in addition, the calibration engine 130 can provide the refined values of the set of parameters 113 for presentation to a user on the user interface device 110, e.g., by providing the refined parameter values or some other digital data derived from the refined parameter values as output data 125 to the user interface device 110.

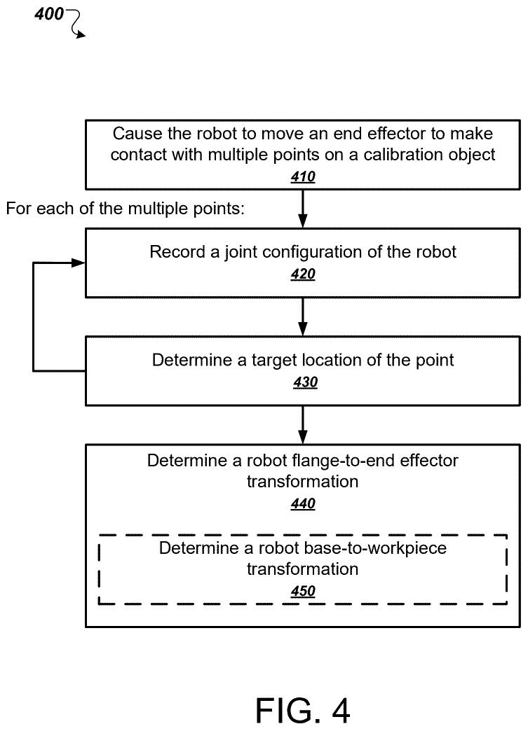

The contact control-based robot calibration process will be described in greater detail below with reference to FIG. 4, but in short, it involves the calibration engine 130 generating robot commands 145 to control the robot 171 to make contact with multiple points on (a surface of) the calibration object 174 and obtaining information including the joint configurations of the robot 171 while it makes contact with the calibration object 174 and the locations of the contact points in a calibration object coordinate frame, which is then used to adjust the set of parameters 113 included in the calibration model 135.

The contact sensor 173 is typically attached to (a distal end of) the end effector 172 of the robot 171, and can be used to detect whether the end effector 172 is in contact with another object in the workcell 170.

In one example, the contact sensor 173 is a force sensor which can sense forces applied to the end effector 172 during robot movement. For example, the force can represent a contact force between the end effector 172 and another object in the workcell 170. In this example, the calibration engine 130 receives the sensor measurements 155 which include force values during movement of the robot 171, and determines whether the end effector 172 is in contact with the calibration object 174 (or another object) in the workcell 170.

For example, the calibration engine 130 can determine a reference force value indicating that the end effector 172 is not in contact with any external object. If the force sensor provides a force value that exceeds the reference force value, the calibration engine 130 determines that the end effector 172 is in contact with the calibration object 174 in the workcell 170.

Other types of the contact sensor 173 are possible. For example, the contact sensor 173 can include a retractable pin coupled to a base (which is in turn coupled to the end effector 172 of the robot 171). If the end effector 172 contacts an object, the pin may be pushed inwards and thus displaces from a default position, indicating that a physical contact has been made. Further examples of the contact sensor 173 include contact switches, mechanical contact sensors, and other sensors configured to detect contact with another object.

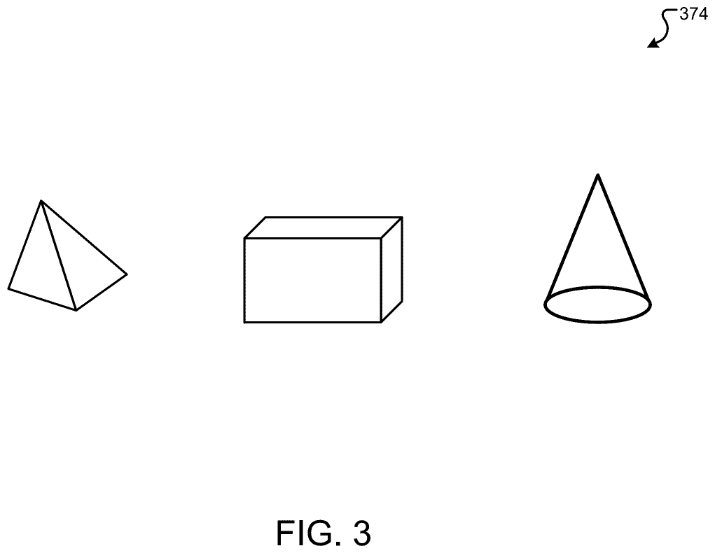

FIG. 3 illustrates examples of a calibration object 374 that can be used in a contact control-based robot calibration process. The calibration object 374 can be the same as or similar to the calibration object 174 included in the workcell 170 of FIG. 1.

In general, the calibration object 374 can be any three-dimensional (3-D) object that has a known geometry. That is, the geometric characteristics of the calibration object 374 are made available to the system 100 at the time the contact control-based robot calibration process is being performed. In this specification, a “3-D object” refers to an object that has a height, width, and depth. In contrast, a “two-dimensional object” or “2-D object” refers to an object having only two dimensions (e.g., a width along an x-axis and a height along a y-axis) and not having a third dimension (e.g., a depth along a z-axis). Examples of a 2-D object include a planar object, and any other object that can be approximated by a plane.

In one example illustrated in FIG. 3, the calibration object 374 has a pyramid shape. In geometry, a pyramid is a polyhedron formed by connecting a polygonal base and a point, called the apex. The polygonal base includes multiple base edges. Each base edge and apex form a triangle. In this example, having a known geometry thus means that at least the lengths of and the angles between the base edges and the position of the apex relative to the polygonal base are made available to the system 100.

In another example illustrated in FIG. 3, the calibration object 374 has a cuboid shape. In geometry, a cuboid has 12 edges which meet at right angles, eight vertices, and six rectangular faces. In this example, having a known geometry thus means that at least the length of each of the 12 edges are made available to the system 100.

In a further example illustrated in FIG. 3, the calibration object 374 has a cone shape. In geometry, a cone has a circular base and a pointed edge at the top, called the apex. A cone has one face that tapers smoothly from the circular base to the apex. In this example, having a known geometry thus means that at least the radius of the circular base and the position of the apex relative to the circular base are made available to the system 100.

These example shapes are for illustration only, and the calibration object can have other shapes as well. For example, the calibration object can have a cube shape, a triangular prism shape, cylinder shape, a sphere, and so forth.

FIG. 4 is a flow diagram of an example process 400 of contact control-based robot calibration. For convenience, the process 400 will be described as being performed by a system of one or more computers located in one or more locations. For example, a system for calibrating a robot, e.g., the system 100 of FIG. 1, appropriately programmed, can perform the process 400.

In general, the process 400 can be repeated for each of a plurality of workcells. Each workcell includes a robot, a calibration object, and a workpiece. The robot can be any robot that includes an arm, an end effector at the end of the arm, and a base. The arm includes a plurality of joints and a plurality of links. The end effector can be a tool, e.g., a welding device, spray gun, or a gripper, to name just a few examples. For each workcell, the process 400 can be repeated as often as necessary to generate the latest refined values of a set of parameters included in a calibration model of the robot that can be used to generate robot commands for controlling the robot to follow a robot trajectory to perform one or more tasks.

The system generates robot commands that cause the robot to move an end effector to make contact with multiple points on a calibration object within the workcell (step 410). The calibration object can be any three-dimensional (3-D) object that has a known geometry. In particular, the calibration object can be placed in a reserved location in the workcell, and the multiple points can correspond to spatially distinct points on one or more surfaces of the calibration object.

Such a calibration object may be viewed as a non-functional object. In this specification, being “non-functional” means that the calibration object will not be needed once after the calibration process is completed, i.e., when performing one or more tasks. This is in contrast to the workpiece, which may be viewed as a “functional” object because the performance of the one or more tasks typically involves the robot using the end effector to manipulate the workpiece in one way or another.

The reserved location at which the calibration object is placed can generally be any predetermined location in the workcell. In some implementations, a fixture is used to securely hold the workpiece at the reserved location in the workcell. For example, the fixture can be a clamp, a suction cup, or a magnet for securing the calibration object at the reserved location.

In some implementations, the system determines whether the end effector has made contact with the calibration object through force sensing, i.e., based on force values reported by a force sensor that is attached to the end effector of the robot while it is moving. In other implementations, the system does this based on using another type of a contact sensor, e.g., a retractable pin, a contact switch, a mechanical contact sensor, or another device that can be configured to detect contact.

The system repeatedly performs the following steps 420 and 430 for each of the multiple points at which the end effector makes contact with the calibration object.

The system reads joint configurations of the robot when the robot is holding the end effector in contact with the point at which the end effector makes contact with the calibration object (step 420). For example, every time a contact between the end effector and the calibration object has been made, the system can make a read request to a controller of robot in order to read (and record) the joint configuration (e.g., the joint angles) of each of the plurality of joints of the robot.

The system determines a target location of the point in an end effector coordinate frame based on the known geometry of the calibration object (step 430). For example, the target location of the point can be an exact location that is defined in 3-D coordinates. As another example, the target location of the point can be an approximate location that is defined using fewer or more coordinate values.

In the example of FIG. 3, the approximate location of the point can be defined by coordinate values that identify a particular triangle (which is a plane) from among multiple triangles of pyramid, or that identify a particular rectangular face (which is also a plane) from among multiple rectangular faces of the cuboid, on which the contact has been made. For example, in the equation (Ax+By+Cz+D=0) of a plane in any 3-D coordinate space, the values of coefficients A, B, C, and D can be derived from the known geometry of the calibration object, and x, y, z are coordinate values that define the approximate location.

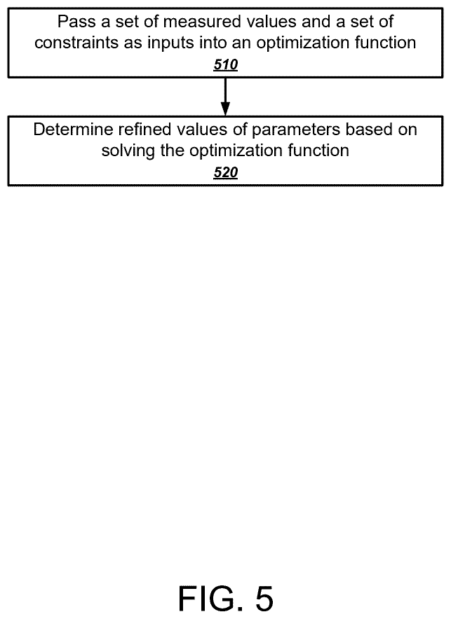

The system determines, based on (i) the read joint configurations of the robot and (ii) the target locations of the points in the end effector coordinate frame, a robot flange-to-end effector transformation between the robot coordinate frame and the end effector coordinate frame (step 440). Step 440 is explained in more detail with reference to FIG. 5, which shows sub-steps 510-520 corresponding to step 440.

The system passes a set of measured values and a set of constraints as inputs into an optimization function (step 510). The set of measured values include (1) values that define a transformation between the robot base and the robot flange and that can be derived from the joint configuration (e.g., joint angles) of the robot, and (2) values that define a transformation between a base of the end effector and a tip of the end effector and that can be derived from the known configuration (e.g., dimensions) of the end effector. The set of constraints are defined by the known geometry of the calibration object.

The system determines, based on solving the optimization function using a nonlinear optimization algorithm, refined values of the parameters included in the calibration model of the robot that define the robot flange-to-end effector transformation between the robot flange coordinate frame to the end effector coordinate frame (step 520).

Any one of a number of nonlinear optimization algorithms can be used to solve the optimization function and thereby determine the refined values of the parameters included in the calibration model of the robot. For example, some implementations of the system can perform this optimization in accordance with a Levenberg-Marquardt optimization or with other nonlinear optimization algorithms such as a partial Levenberg Marquardt technique or a Broyden-Fletcher-Goldfarb-Shanno (BFGS) algorithm.

Optionally, the system jointly determines, based on solving the optimization function using the nonlinear optimization algorithms, refined values of the parameters included in the calibration model of the robot that define the robot base-to-calibration object transformation (step 450). That is, step 450 can be performed as part of step 440. The robot base-to-calibration object transformation defines a transformation between the robot base coordinate frame and the calibration object coordinate frame.

After performing the process 400 to update the calibration model of the robot by generating refined values of the set(s) of parameters included in the calibration model, the system can use the updated calibration model to generate robot commands for controlling the robot to follow a robot trajectory to perform one or more tasks.

For example, the robot trajectory may be an end effector trajectory defined in a workpiece coordinate frame, and system can obtain, e.g., from a user of the system, data defining a transformation between the calibration object coordinate frame and the workpiece coordinate frame. Because the robot base-to-calibration object transformation has now been determined, the system can then determine a robot base-to-workpiece transformation between the robot base coordinate frame and the workpiece coordinate frame by composing a sequence of transformations from the robot base coordinate frame, through the calibration object coordinate frame, to the workpiece coordinate frame. After that, the system can generate robot commands based on the robot base-to-workpiece transformation to control the robot to manipulate the workpiece. In this example, the transformation from the robot base coordinate frame to the calibration object coordinate frame is defined by the refined values of a corresponding set of translational and rotational parameters included in the calibration model of the robot.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
A method for calibrating a robot in a workcell, wherein the method comprises:
causing the robot to move an end effector to make contact with multiple points on a calibration object within the workcell, wherein the robot defines a robot flange coordinate frame and the end effector defines an end effector coordinate frame;
for each of the multiple points at which the end effector made contact with the calibration object:
   reading joint configurations of the robot when the robot is holding the end effector in contact with the point; and
   determining a target location of the point in the end effector coordinate frame based on a known geometry of the calibration object; and
determining, based on (i) the read joint configurations of the robot and (ii) the target locations of the points in the end effector coordinate frame, a robot flange-to-end effector transformation between the robot flange coordinate frame and the end effector coordinate frame.

Embodiment 2 is the method of embodiment 1, wherein the robot also defines a robot base coordinate frame, wherein the calibration object defines a calibration object coordinate frame, and wherein the method further comprises:
determining, based at least on the target locations of the points in the end effector coordinate frame, a robot base-to-calibration object transformation between the robot base coordinate frame and the calibration object coordinate frame.

Embodiment 3 is the method of any one of embodiments 1-2, wherein the robot base coordinate frame has an origin at a center of a base of the robot.

Embodiment 4 is the method of any one of embodiments 1-3, wherein determining the robot flange-to-end effector transformation comprises:
passing a set of measured values and a set of constraints as inputs into an optimization function; and
determining, based on using a nonlinear optimization algorithm to solve the optimization function, refined values of a set of parameters that define the robot flange-to-end effector transformation.

Embodiment 5 is the method of any one of embodiments 1-4, wherein the calibration object has a three-dimensional (3-D) shape.

Embodiment 6 is the method of any one of embodiments 1-5, wherein the calibration object is a non-functional object placed in a reserved location in the workcell.

Embodiment 7 is the method of any one of embodiments 1-6, wherein causing the robot to move the end effector to make contact with multiple points on the calibration object comprises:
determining whether the end effector makes contact with the calibration object through force sensing.

Embodiment 8 is the method of claim 2, wherein the workcell comprises a workpiece that defines a workpiece coordinate frame, and wherein the method further comprises:
obtaining a transformation between the calibration object coordinate frame and the workpiece coordinate frame; and
determining a robot base-to-workpiece transformation between the robot base coordinate frame and the workpiece coordinate frame.

Embodiment 9 is the method of claim 8, further comprising:
generating commands based on the robot base-to-workpiece transformation to control the robot to manipulate the workpiece.

Embodiment 10 is a system comprising: one or more computers and one or more storage devices storing instructions that are operable, when executed by the one or more computers, to cause the one or more computers to perform the method of any one of embodiments 1 to 9.

Embodiment 11 is a computer storage medium encoded with a computer program, the program comprising instructions that are operable, when executed by data processing apparatus, to cause the data processing apparatus to perform the method of any one of embodiments 1 to 9.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method for calibrating a robot in a workcell, wherein the method comprises:
causing the robot to move an end effector to make contact with multiple points on a calibration object within the workcell, wherein the robot defines a robot flange coordinate frame and the end effector defines an end effector coordinate frame;
for each of the multiple points at which the end effector made contact with the calibration object:
reading joint configurations of the robot when the robot is holding the end effector in contact with the point; and
determining a target location of the point in the end effector coordinate frame based on a known geometry of the calibration object; and
determining, based on (i) the read joint configurations of the robot and (ii) the target locations of the points in the end effector coordinate frame, a robot flange-to-end effector transformation between the robot flange coordinate frame and the end effector coordinate frame.

2. The method of claim 1, wherein the robot also defines a robot base coordinate frame, wherein the calibration object defines a calibration object coordinate frame, and wherein the method further comprises:
determining, based at least on the target locations of the points in the end effector coordinate frame, a robot base-to-calibration object transformation between the robot base coordinate frame and the calibration object coordinate frame.

3. The method of claim 2, wherein the robot base coordinate frame has an origin at a center of a base of the robot.

4. The method of claim 1, wherein determining the robot flange-to-end effector transformation comprises:
passing a set of measured values and a set of constraints as inputs into an optimization function; and
determining, based on using a nonlinear optimization algorithm to solve the optimization function, refined values of a set of parameters that define the robot flange-to-end effector transformation.

5. The method of claim 1, wherein the calibration object has a three-dimensional (3-D) shape.

6. The method of claim 1, wherein the calibration object is a non-functional object placed in a reserved location in the workcell.

7. The method of claim 1, wherein causing the robot to move the end effector to make contact with multiple points on the calibration object comprises:
determining whether the end effector makes contact with the calibration object through force sensing.

8. The method of claim 2, wherein the workcell comprises a workpiece that defines a workpiece coordinate frame, and wherein the method further comprises:
obtaining a transformation between the calibration object coordinate frame and the workpiece coordinate frame; and
determining a robot base-to-workpiece transformation between the robot base coordinate frame and the workpiece coordinate frame.

9. The method of claim 8, further comprising:
generating commands based on the robot base-to-workpiece transformation to control the robot to manipulate the workpiece.

10. A system comprising one or more computers and one or more storage devices storing instructions that when executed by one or more computers cause the one or more computers to perform operations for calibrating a robot in a workcell, wherein the operations comprise:
causing the robot to move an end effector to make contact with multiple points on a calibration object within the workcell, wherein the robot defines a robot flange coordinate frame and the end effector defines an end effector coordinate frame;
for each of the multiple points at which the end effector made contact with the calibration object:
reading joint configurations of the robot when the robot is holding the end effector in contact with the point; and
determining a target location of the point in the end effector coordinate frame based on a known geometry of the calibration object; and
determining, based on (i) the read joint configurations of the robot and (ii) the target locations of the points in the end effector coordinate frame, a robot flange-to-end effector transformation between the robot flange coordinate frame and the end effector coordinate frame.

11. The system of claim 10, wherein the robot also defines a robot base coordinate frame, wherein the calibration object defines a calibration object coordinate frame, and wherein the method further comprises:
determining, based at least on the target locations of the points in the end effector coordinate frame, a robot base-to-calibration object transformation between the robot base coordinate frame and the calibration object coordinate frame.

12. The system of claim 10, wherein the robot base coordinate frame has an origin at a center of a base of the robot.

13. The system of claim 10, wherein determining the robot flange-to-end effector transformation comprises:
passing a set of measured values and a set of constraints as inputs into an optimization function; and
determining, based on using a nonlinear optimization algorithm to solve the optimization function, refined values of a set of parameters that define the robot flange-to-end effector transformation.

14. The system of claim 10, wherein the calibration object has a three-dimensional (3-D) shape.

15. The system of claim 10, wherein the calibration object is a non-functional object placed in a reserved location in the workcell.

16. The system of claim 10, wherein causing the robot to move the end effector to make contact with multiple points on the calibration object comprises:
determining whether the end effector makes contact with the calibration object through force sensing.

17. The system of claim 10, wherein the workcell comprises a workpiece that defines a workpiece coordinate frame, and wherein the method further comprises:
obtaining a transformation between the calibration object coordinate frame and the workpiece coordinate frame; and
determining a robot base-to-workpiece transformation between the robot base coordinate frame and the workpiece coordinate frame.

18. The system of claim 17, wherein the operations further comprise:
generating commands based on the robot base-to-workpiece transformation to control the robot to manipulate the workpiece.

19. One or more computer-readable storage media storing instructions that when executed by one or more computers cause the one or more computers to perform operations for calibrating a robot in a workcell, wherein the operations comprise:
causing the robot to move an end effector to make contact with multiple points on a calibration object within the workcell, wherein the robot defines a robot flange coordinate frame and the end effector defines an end effector coordinate frame;
for each of the multiple points at which the end effector made contact with the calibration object:
reading joint configurations of the robot when the robot is holding the end effector in contact with the point; and
determining a target location of the point in the end effector coordinate frame based on a known geometry of the calibration object; and
determining, based on (i) the read joint configurations of the robot and (ii) the target locations of the points in the end effector coordinate frame, a robot flange-to-end effector transformation between the robot flange coordinate frame and the end effector coordinate frame.

20. The computer-readable storage media of claim 19, wherein the robot also defines a robot base coordinate frame, wherein the calibration object defines a calibration object coordinate frame, and wherein the method further comprises:
determining, based at least on the target locations of the points in the end effector coordinate frame, a robot base-to-calibration object transformation between the robot base coordinate frame and the calibration object coordinate frame.
